(19) United States
(12) Patent Application Publication
(10) Pub. No.: US 2017/0088206 A1
(43) Pub. Date: Mar. 30, 2017

(54) AUTONOMOUS CRAWLING SYSTEM

(71) Applicant: Airbus Defence and Space, S.A.U., Madrid (ES)

(72) Inventors: Fernando ESTEBAN FINCK, Madrid (ES); Juan Enrique JURADO GARRIDO, Madrid (ES); Francisco Jose LEON AREVALO, Madrid (ES); Alfonso MEMBIELA CABEZA, Madrid (ES); Clemente DE LA CUADRA JIMENEZ PLACER, Madrid (ES)

(21) Appl. No.: 15/278,848

(22) Filed: Sep. 28, 2016

(30) Foreign Application Priority Data
Sep. 28, 2015 (EP) 15382467.7

(51) Int. Cl. B62D 57/032; B21J 15/14; B64F 5/00

(52) U.S. Cl. CPC B62D 57/032; B64F 5/0009; B21J 15/142; Y10S 901/01

(57) ABSTRACT

An automaton system (10) adapted for moving on a surface (S) including: movement means (1) for moving the automaton system on said surface, and actuation means (2) attached to the movement means (1) adapted for acting on the surface, wherein the movement means (1) are adapted for being supported on the surface at a fixed height (h), and in that the actuation means (2) are attached to the movement means (1) by means of an adaptation structure (3), such that the adaptation structure (3) allows the actuation means (2) to act on the surface (S) perpendicular to the tangent of the surface (S) at a point of actuation (A).

### RELATED APPLICATION

This application claims priority to European Patent Application EP15382467.7 filed Sep. 28, 2015, the entirety of which is incorporated by reference.

### TECHNICAL FIELD

The present invention relates to an autonomous crawling system for crawling on surfaces. It particularly relates to a crawling system for crawling on aeronautical surfaces for performing work on said surfaces.

### BACKGROUND

There are currently different solutions for drilling and riveting aeronautical structures. Most of them involve fixed large-sized installations custom-designed for each specific application and they require complex and expensive equipment. These installations do not adapt to different surfaces and require installation and configuration, such that their movement to other production zones or areas is unfeasible. Some equipment performs drilling operations, rivet insertion and sealant application using machine vision systems which position the different tools at given work points.

The alternative to these installations can be semi-automatic drilling and subsequent riveting operations, assuring the attachment of the surfaces to be riveted by means of clamps.

There are different attempts to solve the problem of riveting surfaces by means of a device that is versatile and adapts to different surfaces. These systems also use machine vision systems, furthermore being equipment of a considerable span and weight that do not allow use in any aeronautical surface.

European Patent Application EP 1 884 453 A2 describes a crawler robot equipped with a work unit, and control system for such robot. The technical problem of this solution is that it requires an algorithm that adapts to the surfaces on which it must crawl to achieve perpendicularity between the surface and the actuation device at a point of actuation. Obtaining the algorithms, work equipment for obtaining them and the adaptation system of a robot to provide said perpendicularity increase both the weight of the systems as well as their cost.

### SUMMARY

A novel invention is disclosed herein which, in a first embodiment, is automaton system adapted for moving on a surface and comprising: movement means, e.g., a movement device, for moving the automaton system on said surface, the actuation means, e.g., an actuation device, is attached to the movement means by means of an adaptation structure, such that the adaptation structure allows the actuation means to act on the surface perpendicular to the tangent of the surface at a point of actuation.

The automaton system may be configured to obtain perpendicularity at a work point. Perpendicularity may be obtained without having to use algorithms to calculate a curvature of a surface on which the automaton system is seated. In contrast, the adaptation structure is adapted for following the curvature of a known work surface.

In particular embodiments, the automaton system comprises positioning means adapted for adjusting the position of the actuation means, where the positioning means are attached to the movement means through the adaptation structure.

The positioning means, in addition to the movement means, allow a precise adjustment of the point of actuation. In other words, the movement means allow the automaton system to move on a surface, and furthermore, advantageously, once the automaton system has moved the actuation position is specified by means of the positioning means, allowing perpendicular actuation on a specific point through the adaptation structure.

In particular embodiments, the movement means comprise: an outer structure and an inner structure internal to the outer structure and attached to it by means of at least one movement arm.

This embodiment allows having a simple and easy-to-handle autonomous system. Furthermore, it allows the manufacture thereof with structures that allow adopting different sizes according to actuation needs. The movement arm allows an articulated motion between the two structures which, in several embodiments, in a non-limiting manner, are rectangular, square, or circular.

In particular embodiments, the movement arm comprises a connecting rod-crank mechanism.

In particular embodiments, the movement means comprise a DC motor. Advantageously, these motors allow for savings in weight and size of the motor with respect to AC motors, which allows covering power needs of the autonomous crawling system.

In particular embodiments, the adaptation structure comprises a rail having a curvature coinciding with the curvature of the surface on which to act. This rail allows the positioning means to be guided in their motion until reaching the actuation position perpendicular to the surface.

In particular embodiments, the positioning means comprise display means, for example a video camera. This allows controlling the position of the actuation means by means of displaying the point of actuation on an external monitor, for example. In alternative embodiments, the positioning means comprise mark tracing means, for example, by means of a laser that tracks marks or grooves on the surface to determine the correct positioning of the actuation means.

In particular embodiments, the positioning means further comprise a profilometer. The profilometer may be a contactless-type profilometer, for example a laser, for measuring the topology of the surface to be reproduced in the rail. Advantageously, such profilometers allow reliability, speed, surface adaptability and simplicity, having a small-sized profilometer.

In particular embodiments, the movement means comprise fixing means for fixing to the surface, for example suction cups. Suction cups allow adhesion to the work surface. For example during movement, once the suction cups come into contact with the surface, a vacuum is created and the suction cups are fixed. In the next step, the suction cups are fixed and serve as support.

In particular embodiments, the actuation means comprise a riveter. This embodiment allows using the automaton system as an autonomous riveting system adapted for moving on surfaces, for example aeronautical surfaces.

In particular embodiments, the actuation means comprise a drill. This embodiment allows using the automaton system as an autonomous drilling system adapted for moving on surfaces, for example aeronautical surfaces. By means of the positioning system, the actuation means, in this case drilling means, are positioned on the point to be drilled and work perpendicular to the tangent of the surface at the point of actuation is allowed.

In particular embodiments, the automaton system comprises a set of adaptation structures having different curvatures such that they adapt to different surfaces. In these embodiments, the automaton system is adapted for receiving different adaptation structures according to the surface on which it must move, thereby obtaining a versatile and comfortable-to-use system.

The present invention allows drilling, inserting rivets and, for example, applying a sealant with the corresponding actuation means, in an autonomous and portable manner.

The present invention may be embodied to have one or more of the following advantages: (i) it allows autonomously drilling and riveting surfaces with different curvatures, (ii) it is a moving or portable system, (iii) it minimizes surface clamping needs because the weight and size of the autonomous crawling system is less than that of other known systems and special positioning of the work surfaces is not required; it allows working locally, (iv) it prevents fixed installations, preparation needs and high maintenance needs, (v) it is a lightweight and easy-to-operate system, and (vi) it is a system that can be configured for different materials and configurations of the structure to be riveted.

### DESCRIPTION OF THE DRAWINGS

These and other features and advantages of the invention will be more clearly understood based on the following detailed description of an embodiment, given solely by way of illustrative and non-limiting example, in reference to the attached drawings.

FIG. 1 shows an example of an automaton system adapted for moving on a surface according to the invention.

FIG. 2A shows a perspective view of the movement means of a system according to the invention.

FIG. 2B shows a plan view of the movement means of a system according to the invention.

FIG. 3 shows the continuous motion sequence in a direction of the movement means of a system according to the invention.

FIG. 4 shows a plan view of the inner structure comprising an orthogonal shaft system in a system according to the invention.

FIG. 5 shows a drilling and riveting system comprising two autonomous systems working together in tandem.

FIG. 6 shows a particular example of the lateral movement system.

FIG. 7 shows a particular example of the fine movement system.

### DETAILED DESCRIPTION

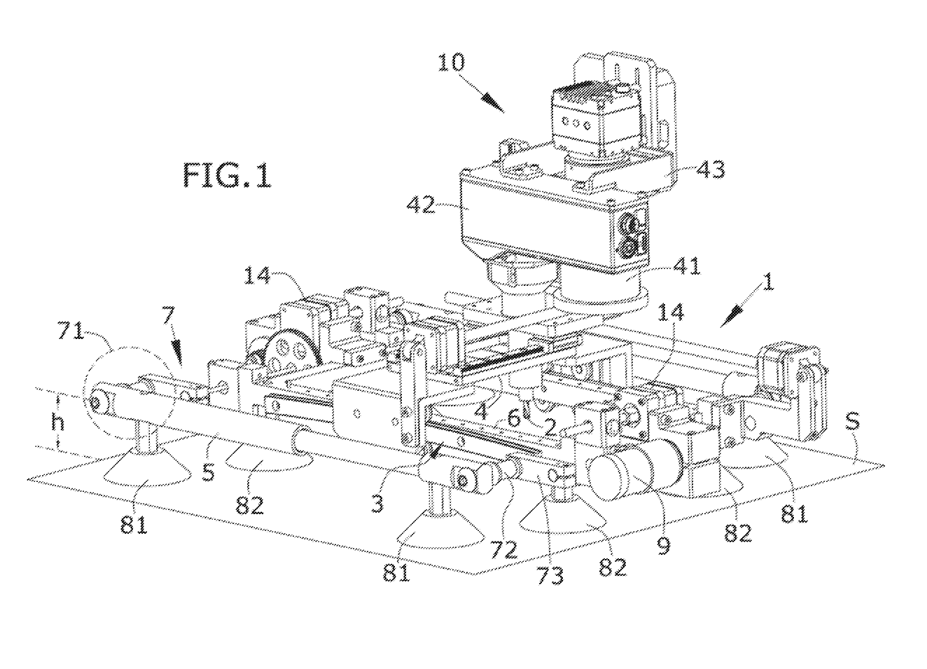

FIG. 1 shows an automaton system (10) adapted for moving on a surface (S), the system comprising: movement means (1) for moving the automaton system on said surface, and actuation means (2) attached to the movement means (1) adapted for acting on the surface. An automaton is a moving mechanical device such as a device capable of moving over a surface. An automaton may move under control of a human operator or under automatic control of programmed instructions.

The movement means (1) in FIG. 1 are adapted for being supported on the surface at a fixed height (h) determined by means of suction cups (81). In the example of the drawing, the actuation means (2) are attached to the movement means (1) by means of an adaptation structure (3). The adaptation structure (3), which in the example comprises two rails having a curvature coinciding with the curvature of the surface (S) on which to act, allows the actuation means (2) to act on the surface (S) perpendicular to the tangent of the surface (S) at a point of actuation (A). FIG. 1 furthermore shows a display video camera (41).

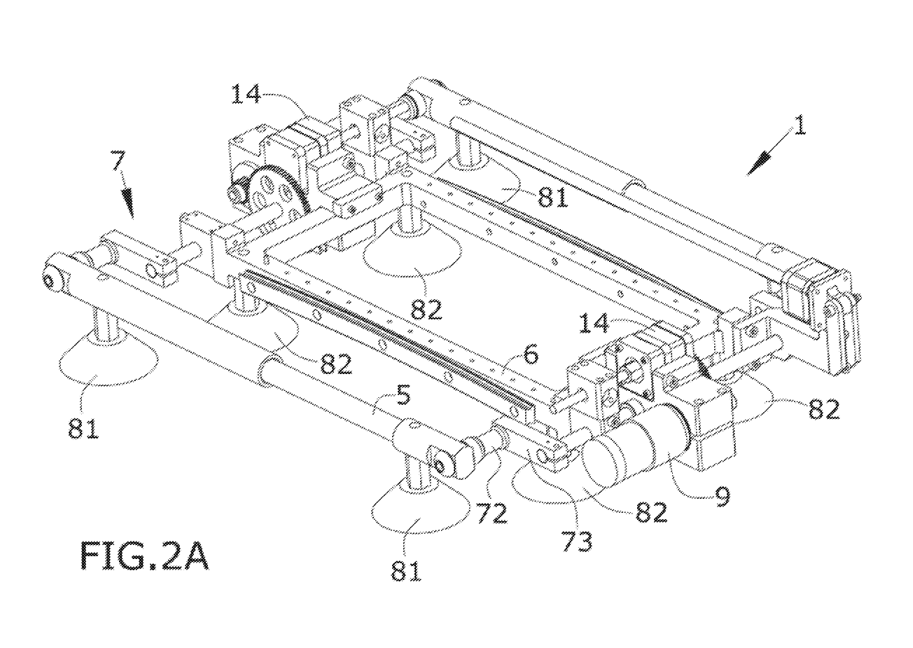

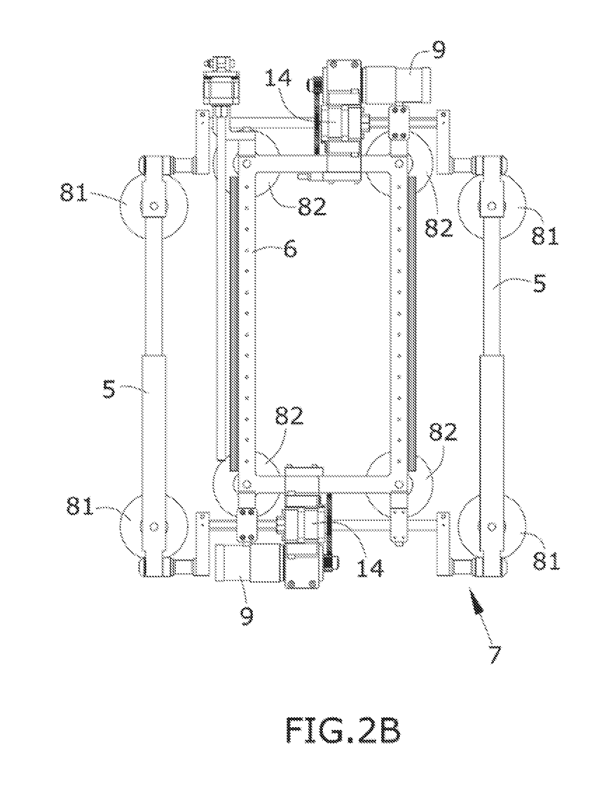

FIGS. 2A and 2B show two views of the movement means of the example shown. The movement means (1) in this example comprise two structures or frames (5, 6): an outer frame (5) and another inner frame (6), each one respectively comprising four suction cups (81, 82) at their ends. The outer frame (5) comprises movement arms (7). In a particular embodiment the movement arm (7) is a connecting rod-crank mechanism (71) that allows movement in one direction. Two DC motors (9) operate the cranks (72) and these in turn move the connecting rods (73). During movement, the suction cups (81, 82) come into contact with the surface (S), the vacuum is created and the suction cups are fixed. In a later step, the suction cups (81) of the connecting rod-crank assembly (71) are fixed and serve to support the automaton system (10). When the cranks (72) which are attached to the inner frame (6) rotate through the shaft of the motor (9), them make the inner frame (6) take one step. When the suction cups (82) come into contact with the surface (S), the vacuum is created and they are fixed to it, so the 8 suction cups (81, 82) fix the assembly to the work surface (S). By repeating the cycle the continuous motion in one direction is achieved, as indicated in FIG. 3. Once the suction cups (82) come into contact with the surface (S), they are fixed to same. Another rotation of the motors (9) makes the inner frame (6) move in the forward direction movement, previously cancelling out the vacuum force acting through these suction cups (82).

The connecting rod-crank mechanism (71) allows taking discreet steps and they can optionally be adapted to the work surface (S) by modifying the length of the connecting rod (73) itself. Therefore, when working on a flat surface or with very high radii of curvature, i.e., little curvature, the length of the connecting rod (73) remains fixed and the motors (9) operating the cranks (72) are synchronized. In particular examples, the autonomous system comprises control software that allows certain desynchronization between the motors (9) such that one rotates somewhat more than the other one does. Advantageously, if the curvature of a surface increases and there are singular points in motion kinematics, this control system allows adapting the suction cups (81) of the connecting rods (73) to the curvature, so modifying the length of the connecting rod (73) is allowed; this prevents the forward movement of the suction cups (81) associated with a shaft of the motor (9) from coinciding with the forward movement of the suction cups (81) associated with the other shaft; if the two motors (9) rotated synchronously, one of the two groups of suction cups would come into contact with the surface without the same occurring with the other group due to the curvature.

If the motors were not desynchronized, the following would be possible:

(i) some suction cups would come into contact with the work surface while the others would not have done so yet, the motor corresponding to the first rotating ones and “pushing” the suction cup first coming into in contact against the surface itself until the other suction cups also touch the surface and stop both motors, and

(ii) once the first suction cups come into contact, they would stop the two motors, the other suction cups being located in the air.

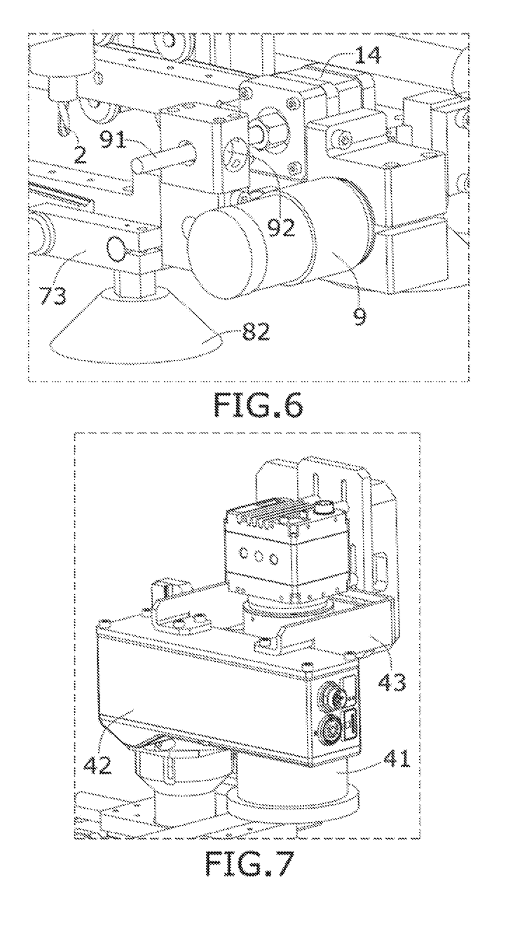

In the example shown in FIGS. 2A, 2B and 3, the inner structure (6) is a chassis or support structure of the entire assembly and on it there are mounted curved rails that can be disassembled and interchanged. These curved rails allow the sliding of the actuation means (2), which in the example comprises a tool holder head (43) for holding a tool, which can generically be any tool, a machine vision camera and a laser profilometer such as that shown in FIG. 7, all with relative positions adjusted for achieving the required functionality.

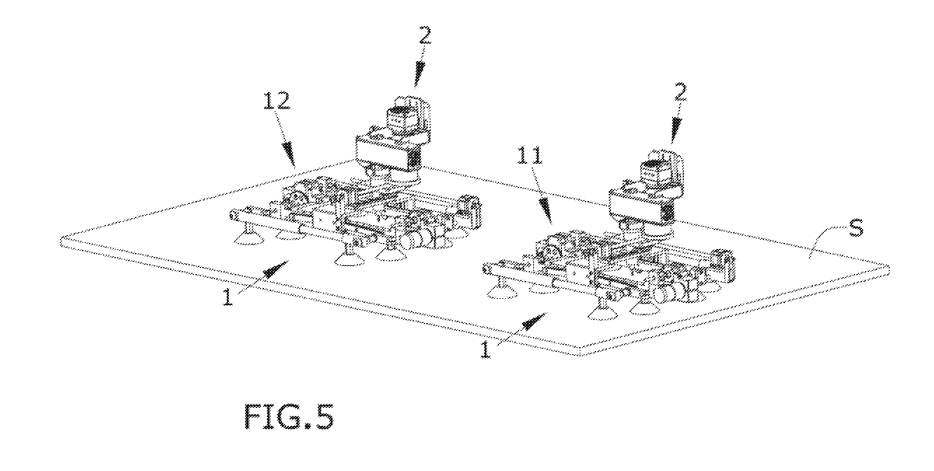

In particular examples, the automaton system incorporates a spindle system (91), as depicted in FIG. 6, which allows the movement in the direction perpendicular to the forward movement direction of the connecting rod-crank mechanism (71) described above. Therefore, by means of the combination of both motions, movement in any direction on the surface is achieved. The lateral movement system is performed with stepper motors (14); the spindle system (91) is connected directly to the corresponding motor (14), the nut (92) being attached to the inner frame (6). The block supporting the lateral movement system slides along one of the sides perpendicular to the main movement direction of the inner frame (6). The suction cups (82) of the inner frame (6) are fixed and when the motor rotates the entire block of the motor (9) moves, including the suction cups (81) of the outer frame (5). When the movement finishes, the outer suction cups (81) are fixed and the start of the motion of the inner frame (6) is allowed.

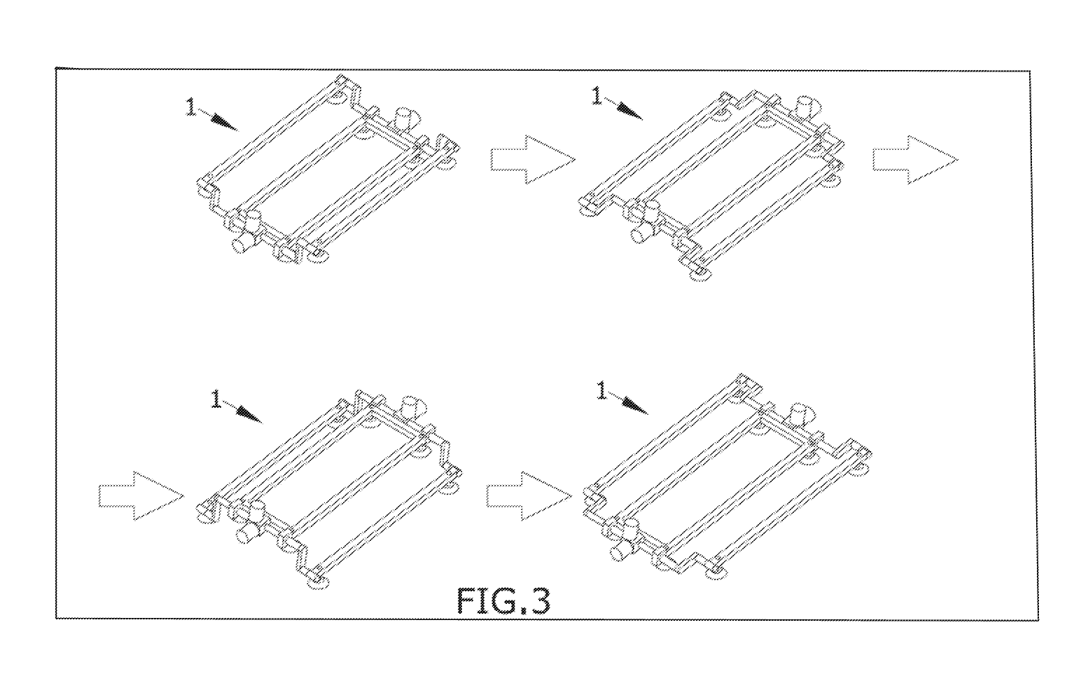

The automaton system (10) comprises positioning means (4) adapted for adjusting the position of the actuation means (2). In the example shown in FIG. 4, the inner structure (6) comprises an orthogonal shaft system (13) on which said positioning means (4) move. FIG. 4 shows said shafts (13), which are operated by respective geared motors (not depicted) comprising position coders. The position coders can be position encoders: devices that translate the angular position of a shaft into a digital signal so that the system can perform control.

In particular examples, the system (10) comprises display means, for example a video camera (41). The positioning of the actuation means (2) is performed based on the display means that are positioned locally, references outside the equipment not being necessary.

The display means recognize a work point in previously defined references on surfaces to be joined together, or drilled, and establishes as theoretical set points the points where actuation is required. The positioning means (4) make the necessary corrections and define the coordinates towards which the actuation means (2) must move. Based on the recognition of the references on the surface (S) and of the information about the position of the actuation means (2), a possible microprocessor provides the necessary orders both for the movement of the complete automaton system (10) and of the actuation means (2) in the shaft system (14) of the inner structure (6).

The actuation means (2) optionally comprise sensors (not shown) that assure perpendicularity thereof on the surface and optionally said actuation means (2) are oriented seeking perpendicularity on the work surface (S) based on the information provided by the sensors incorporated in the head.

In particular examples the automaton system comprises a sensor (no shown) at each of the ends of the structures (5, 6). Advantageously these sensors allow implementing a safety system in order to know how many useful suction cups (81, 82) there are at all times, and it determines if the automaton system (10) can continue to work or if it must stop. In one example, the determination of when a suction cup (81, 82) is useful is by means of its vacuum level. By way of example, if one suction cup (81, 82) does not have a vacuum and the rest do, work may continue, but if three suction cups (81, 82) do not have a sufficient vacuum level, work would be stopped.

The automaton system (10) adapts to any radius of curvature of a surface on which it is to move. Therefore, the position of the suction cups (81) determines the minimum radius for which the movement system is adapted. By modifying the position of the suction cups, the adaptation to any radius of curvature is possible, achieving greater versatility without altering the simplicity of the system.

In particular embodiments, the positioning system (4) is assembled on a tool holder head (43). This tool holder head (43) moves on an adaptation structure (3), which in a particular example is a guide system on the positioning system (4); positioning on the work points (A) is performed in two steps: a first approach step with the positioning system (4) and a second “fine” positioning step by moving the tool holder head (43) on the guide system (3). In a particular example depicted in FIG. 7, the fine movement system comprises software configured for acting on stepper motors (not shown) moving the tool holder head (43) along the guides. The components of the fine positioning system can be a laser profilometer (42), a display camera (41), and control software and hardware.

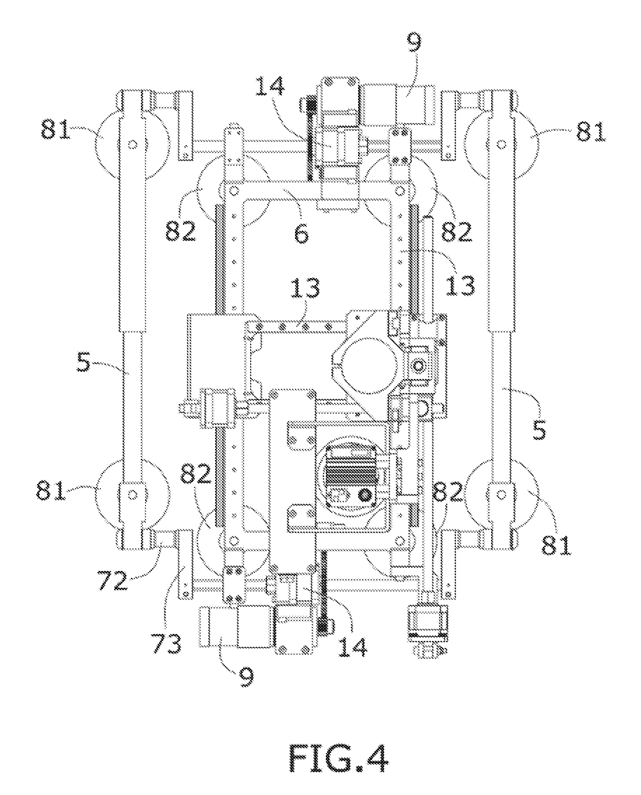

FIG. 5 shows a drilling and riveting system comprising two autonomous systems (11, 12) working together in tandem to attach two surfaces (S). The first system (11) is a drilling unit, because the actuation means comprise a drill. The first system (11) drills pre-defined work points in the surfaces (S) to be attached. The first system (11) optionally comprises a self-centering system to assure that the drill is inserted correctly.

The second system (12) inserts rivets and applies sealant in the boreholes made by the first system (11) or the drilling unit (11). Both systems (11, 12) incorporate the same movement means (1), and differ from one another in the actuation means (2). The rivets can optionally be dispensed automatically from connected equipment or they can be dispensed semi-continuously by means of loaders comprised in the second system (12) or riveting unit.

An optional safety system prevents the second system (2) or riveting unit from reaching the first system (11) or drilling unit, assuring that an optimal safety distance that minimizes mechanical fixing needs prior to riveting the surfaces is maintained.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. An automaton system adapted for moving on a surface, the system comprising
a movement device configured to move the automaton system on said surface,
an actuation device attached to the movement device and configured to act on the surface,
wherein the movement device is adapted to be supported on the surface at a fixed height (h) above the surface, and
wherein the actuation device is attached to the movement device by an adaptation structure, such that the adaptation structure allows the actuation device to act on the surface perpendicular to a tangent of the surface at a point of actuation.

2. The automaton system according to claim 1, further comprising a positioner adapted to adjust a position of the actuation device, where the positioner is attached to the movement device through the adaptation structure.

3. The automaton system according to claim 1, wherein the movement device comprises:
an outer structure, and
an inner structure within the outer structure and attached to the outer structure by at least one movement arm.

4. The automaton system according to claim 3, where the movement arm comprises a connecting rod-crank mechanism.

5. The automaton system according to claim 1, wherein the movement device comprises a motor.

6. The automaton system according to claim 1, wherein the adaptation structure comprises a rail having a curvature coinciding with a curvature of the surface below the automaton system.

7. The automaton system according to claim 2, wherein the positioner comprises a display.

8. The automaton system according to claim 7, where the positioner further comprises a profilometer.

9. The automaton system according to claim 1, wherein the movement device comprises a fixation device configured to be fixed to the surface.

10. The automaton system according to claim 9, where the fixation device comprises suction cups

11. The automation system according to claim 3 wherein the outer structure and the inner structure each include suction cups configured to fix to the surface.

12. The automaton system according to claim 1, wherein the actuation device comprise a riveter or a drill.

13. The automaton system according to claim 2, wherein the positioner comprises sensors configured to sense an end of travel of the positioner with respect to the movement device.

14. A system comprising the automaton system recited in claim 1 and a set of adaptation structures having different curvatures such that they adapt to different surfaces.

15. An automaton system comprising
a movement device configured to crawl over a surface, wherein the movement device includes a first frame and a second frame connected by connection rods to the first frame, wherein the first frame includes legs configured to support the movement device on the surface, and a second frame with legs configured to support the movement device on the surface;
an adaptation structure attached to and supported by the second frame, wherein the adaptation structure includes a moveable mount configured to move in orthogonal directions parallel to a tangent of the surface below the mount;
an actuation device attached to and supported an adaptation structure, wherein the actuation device is held a fixed height above the surface by the adaptation structure and the second frame while the legs of the second frame are on the surface, and
the connection rods are configured to move the second frame and the actuation device with respect to the first frame such that the second frame and the actuation device are and elevated and advanced in a step over the surface while the legs of the first frame remain on the surface and supporting the movement device, wherein the step traverses a distance shorter than a distance movable by the adaptation structure with respect to the second frame.

16. The automaton system of claim 15 wherein the connection rods are each pivotably connected at one end region to the first frame and at an opposite end region pivotably connected to the second frame.

17. The automaton system of claim 15 wherein the actuation device includes a tool configured to modify the surface and a position detection device detecting a region of the surface to be modified by the tool.

18. The automaton system of claim 15 wherein first frame includes parallel support rods, and the second frame is between the parallel support rods of the first frame.
